(19) United States
(12) Patent Application Publication
(10) Pub. No.: US 2025/0253306 A1
(43) Pub. Date: Aug. 7, 2025

(54) ELECTRODE FOIL EDGE TENSIONING

(71) Applicant: GM GLOBAL TECHNOLOGY OPERATIONS LLC, DETROIT, MI (US)

(72) Inventors: Raghavendra Saikrishna Keerthi Manda, Northville, MI (US); Donghao Liu, Troy, MI (US); Wayne Cai, Troy, MI (US); Haiyan Li, Novi, MI (US); Purushotham Reddy Kunduru, Macomb, MI (US)

(21) Appl. No.: 18/433,544

(22) Filed: Feb. 6, 2024

(51) Int. Cl. H01M 4/04

(52) U.S. Cl. CPC H01M 4/0435

(57) ABSTRACT

Aspects of the disclosure include an electrode calendering system that leverages electrode foil edge tensioning to reduce calendering wrinkling and a process for manufacturing electrodes using the same. An exemplary system includes a calendering module having a pair of calendering rollers separated by a gap. The gap includes a distance selected to accommodate a current collector. The current collector includes a bare portion and a coated portion having thereon an active electrode material of a first thickness. The system includes an un-winder module upstream of the calendering module, a collector module downstream of the calendering module, and one or more idle rollers. An idle roller of the one or more idle rollers includes a tensioning sleeve having a second thickness selected, based on the first thickness, to over-tension underlying portions of the current collector, the tensioning sleeve aligned to the bare portion of the current collector.

### INTRODUCTION

The present disclosure relates to battery cell manufacturing, and particularly to an electrode calendering system that leverages electrode foil edge tensioning to reduce calendering wrinkling.

Electrodes are widely used in a range of devices that store electrical energy, including primary (non-rechargeable) battery cells, secondary (rechargeable) battery cells, fuel cells, and capacitors. An ideal electrode needs to balance various electrical energy storage characteristics, such as, for example, energy density, power density, maximum charging rate, internal leakage current, equivalent series resistance (ESR), charge-discharge cycle durability, high electrical conductivity, and low tortuosity. Electrodes often incorporate current collectors to supplement or otherwise improve upon these electrical energy storage characteristics. Current collectors can be added to provide a higher specific conductance and can increase the available contact area to minimize the interfacial contact resistance between the electrode and its terminal.

A current collector is typically a sheet of conductive material to which the active electrode material is attached. Aluminum foil, aluminum alloy, copper alloy, stainless steel, and titanium foil are commonly used as the current collector of an electrode. In some electrode fabrication processes, for example, a film that includes activated carbon powder (i.e., the active electrode material) is attached to a thin aluminum or copper foil using an adhesive layer. To improve the quality of the interfacial bond between the film of active electrode material and the current collector, the combination of the film and the current collector is processed in a pressure laminator, for example, a calendar. This process is generally known as calendering. Thus, the fabrication of an electrode typically involves the production of an active electrode material film and the lamination of that film onto a current collector.

### SUMMARY

In one exemplary embodiment an electrode calendering system that leverages electrode foil edge tensioning to reduce calendering wrinkling is provided for manufacturing electrodes. The roll-to-roll system includes a calendering module having a pair of calendering rollers separated by a gap. The gap includes a distance selected to accommodate a current collector. The current collector includes a bare portion and a coated portion having thereon an active electrode material of a first thickness. The system includes an un-winder module upstream of the calendering module, a collector module downstream of the calendering module, and one or more idle rollers positioned between the un-winder module and the collector module. An idle roller of the one or more idle rollers includes a tensioning sleeve having a second thickness selected, based on the first thickness, to over-tension underlying portions of the current collector. The tensioning sleeve is aligned to the bare portion of the current collector.

In addition to one or more of the features described herein, in some embodiments, calendering pressures incurred during the calendering module serve to correct the over-tensioning applied to the bare portion of the current collector, thereby reducing foil wrinkles post-calendering.

In some embodiments, the tensioning sleeve is fixed to the respective idle roller of the one or more idle rollers using at least one of a press fitting and an adhesive. In some embodiments, the tensioning sleeve is fixed to the respective idle roller of the one or more idle rollers using one or more set screws. In some embodiments, the tensioning sleeve is fixed to the respective idle roller of the one or more idle rollers using one or more leaf springs.

In some embodiments, the tensioning sleeve is tapered.

In some embodiments, the tensioning sleeve includes at least one of a patterned texture having one or more protrusions, one or more divots, or one or more grooves.

In some embodiments, at least one of a line speed and a pulling force of the current collector is adjusted to tune the over-tensioning applied to the bare portion of the current collector.

In some embodiments, one or more dancer rollers are positioned between the un-winder module and the collector module. In some embodiments, the pulling force of the current collector is adjusted by displacing a position of at least one of the one or more dancer rollers.

In another exemplary embodiment a method is provided for manufacturing electrodes. The method includes providing a calendering module having a pair of calendering rollers separated by a gap. The gap includes a distance selected to accommodate a current collector. The current collector includes a bare portion and a coated portion having thereon an active electrode material of a first thickness. The method includes providing an un-winder module upstream of the calendering module, a collector module downstream of the calendering module, and one or more idle rollers positioned between the un-winder module and the collector module. An idle roller of the one or more idle rollers includes a tensioning sleeve having a second thickness selected, based on the first thickness, to over-tension underlying portions of the current collector. The tensioning sleeve is aligned to the bare portion of the current collector.

In addition to one or more of the features described herein, in some embodiments, calendering pressures incurred during the calendering module serve to correct the over-tensioning applied to the bare portion of the current collector, thereby reducing foil wrinkles post-calendering.

In some embodiments, the tensioning sleeve is fixed to the respective idle roller of the one or more idle rollers using at least one of a press fitting and an adhesive. In some embodiments, the tensioning sleeve is fixed to the respective idle roller of the one or more idle rollers using one or more set screws. In some embodiments, the tensioning sleeve is fixed to the respective idle roller of the one or more idle rollers using one or more leaf springs.

In some embodiments, an additional idle roller of the one or more idle rollers is positioned over the coated portion of the current collector. The additional idle roller can include an additional tensioning sleeve having a diameter that is 1 to 4 microns larger than a diameter of the additional idle roller.

In some embodiments, the tensioning sleeve includes at least one of a patterned texture having one or more protrusions, one or more divots, or one or more grooves.

In some embodiments, at least one of a line speed and a pulling force of the current collector is adjusted to tune the over-tensioning applied to the bare portion of the current collector.

In some embodiments, one or more dancer rollers are positioned between the un-winder module and the collector module. In some embodiments, the pulling force of the current collector is adjusted by displacing a position of at least one of the one or more dancer rollers.

### BRIEF DESCRIPTION OF THE DRAWINGS

Other features, advantages and details appear, by way of example only, in the following detailed description, the detailed description referring to the drawings.

FIG. 1 is a vehicle configured in accordance with one or more embodiments;

FIG. 2 is an example configuration of an electrode calendering system in accordance with one or more embodiments;

FIG. 3A is an example configuration of an idle roller of the electrode calendering system of FIG. 2 in accordance with one or more embodiments;

FIGS. 3B, 3C, and 3D illustrate example mounting configurations of the tensioning sleeves of the idle roller of FIG. 3A in accordance with one or more embodiments;

FIG. 4A is an example configuration of an idle roller of the electrode calendering system of FIG. 2 in accordance with one or more embodiments;

FIGS. 4B, 4C, 4D, and 4E illustrate example profile configurations for the tensioning sleeves of the idle roller of FIG. 4A in accordance with one or more embodiments; and

FIG. 5 is a flowchart in accordance with one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Electrodes often incorporate current collectors to supplement or otherwise improve upon the electrical energy storage characteristics of the final integrated device (e.g., a battery). A current collector typically includes a sheet of conductive material (e.g., aluminum foil, copper foil, etc.) to which an active electrode material is attached. To improve the quality of the interfacial bond between the film of the active electrode material and the current collector, the combination of the film and the current collector is processed in a pressure laminator. Thus, the fabrication of an electrode typically involves the production of an active electrode material film and the lamination of that film onto a current collector (the so-called calendering process).

Calendering can be generally defined as the compression of a dried electrode (the latter typically resulting from the coating and drying of an electrode slurry) to reduce its porosity, improve particle contact, and enhance energy or power density. Conventional calendering processes have been used to improve various aspects of battery technology by offering, for example, a higher specific conductance, greater contact areas, and lower contact resistance in the electrode. There are several challenges, however, in optimizing the calendering process.

One such challenge, for example, is that the calendering of electrodes (e.g., cathodes) onto current collector substrates (e.g., foil substrates such as aluminum, stainless steel, and titanium) produces a wrinkling defect when targeting lower porosities. Wrinkling defects (also referred to as uneven elongation) are found at the interface between the coated sections of the current collector (i.e., those portions having pressed electrode films) and the uncoated sections (i.e., bare sections of the current collector) and are caused due to the different material properties and thicknesses of the electrode and substrate materials. These defects worsen as the resultant porosity decreases, meaning that relatively lower porosity electrodes natively suffer from more pervasive wrinkling defects.

While there are several approaches to mitigating wrinkling defects, each comes with of some tradeoff. For example, the naïve approach is to raise the porosity target, resulting in a proportional reduction in wrinkling defects but with decreased electrode conductivity. Another approach is to fully cover the substrate, so that there is no interface at which wrinkle defects can occur. The trade off here is that bare foil sections of the current collector (i.e., those portions not covered with the active electrode material) are ideal for use as battery terminals, and simply removing the bare foil sections reduces battery efficiencies.

This disclosure introduces a new electrode calendering system that leverages electrode foil edge tensioning to reduce calendering wrinkling and a process for manufacturing electrodes using the same. Rather than raising porosity targets or removing (or reducing) the bare foil portions of an electrode, an electrode calendering system described herein is configured to intentionally over-tension the foil during the roll-to-roll pulling process. The foil edge pressures incurred during the calendering process serve to correct (reverse, undo, etc.) this over-tensioning (rather than to introduce novel wrinkles), thereby reducing foil wrinkles post-calendering. In short, foil edge over-tensioning creates localized elongation that is evened out via calendering. Although referred to primarily as “pre-tensioning” in reference to an over-tensioning scheme whereby the foil edge is pre-tensioned prior to calendering, in some embodiments, foil edge over-tensioning can occur after calendering in a so-called post-tensioning scheme. Foil edge over-tensioning can be ensured by adding tensioning sleeves on the idle (or pull) roller(s) before or after the calendering rollers, or by tensioning the electrodes by controlling the dancer roller(s) and line speed, or by a combination of both.

Leveraging an electrode calendering system having a foil edge tensioning scheme in accordance with one or more embodiments offers several technical advantages over prior designs. Notably, the modified electrode manufacturing system and associated process described herein can be used to produce electrodes without (or with greatly reduced) wrinkling defects and with relatively improved elongation. Batteries built from electrodes without wrinkles and with a more even elongation deliver a range of improved battery characteristics, as these defects can reduce electrode integrity (e.g., wrinkles can lead to poor adhesion between the coated electrode film and the current collector, resulting in regions of relatively weak attachment that are prone to delamination or peeling), increase electrical resistance (wrinkles and thickness variations can create gaps or areas of reduced contact between the electrode material and the current collector that can impede the flow of electrons), increase degradation and reduce cycle life (electrodes with wrinkles and/or uneven elongation can experience increased stress and strain during charge-discharge cycles due to inconsistent mechanical properties, which can lead to accelerated degradation, cracking, or even electrode failure), increase thermal instabilities (wrinkles can trap electrolytes and inhibit heat dissipation, resulting in localized hotspots that can degrade the electrolyte), and reduce capacity and energy density (wrinkling and elongation defects can lead to uneven thickness distributions across the electrode surface and these non-uniformities can result in reduced active material utilization, lower capacity, and compromised energy density in the battery). Other advantages are possible. For example, preexisting roll-to-roll processes can be modified in a somewhat straightforward manner via the incorporation of the tensioning sleeves and/or by adjusting the line speed and dance roller positions to reduce wrinkle defects without main roll/calendering roll redesigns. Moreover, reducing wrinkle and elongation defects as described herein obviates the need for foil annealing and foil rigidity steps as well as the need to introduce ridges in the current collector, each of which are techniques typically relied upon for defect mitigation but are known to weaken the foil. In addition, annealing and foil rigidity steps are energy-intensive and expensive.

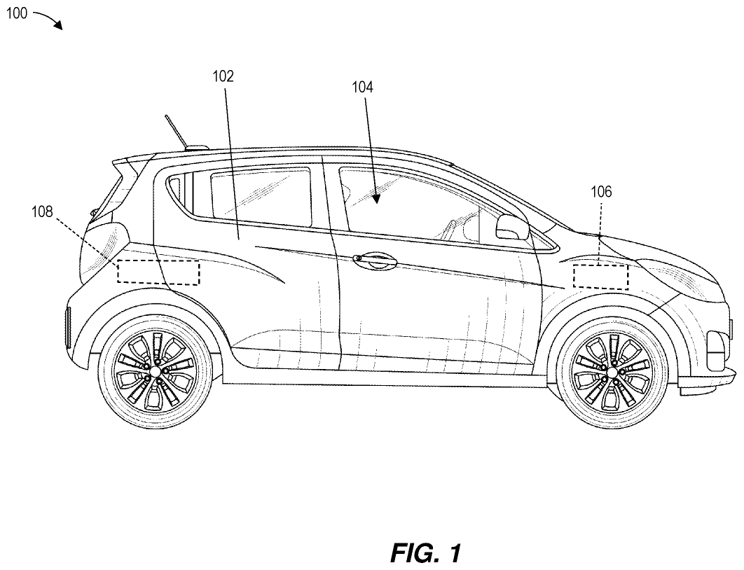

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, an electric motor 106 (shown by projection under the front hood). The electric motor 106 is shown for ease of illustration and discussion only. It should be understood that the configuration, location, size, arrangement, etc., of the electric motor 106 is not meant to be particularly limited, and all such configurations (including multi-motor configurations) are within the contemplated scope of this disclosure.

The electric motor 106 is powered via a battery pack 108 (shown by projection near the rear of the vehicle 100). The battery pack 108 is shown for ease of illustration and discussion only. It should be understood that the configuration, location, size, arrangement, etc., of the battery pack 108 is not meant to be particularly limited, and all such configurations (including split configurations) are within the contemplated scope of this disclosure. Moreover, while the present disclosure is discussed primarily in the context of a battery pack 108 configured for the electric motor 106 of the vehicle 100, aspects described herein can be similarly incorporated within any system (vehicle, building, or otherwise) having an energy storage system(s) (e.g., one or more battery packs or modules), and all such configurations and applications are within the contemplated scope of this disclosure.

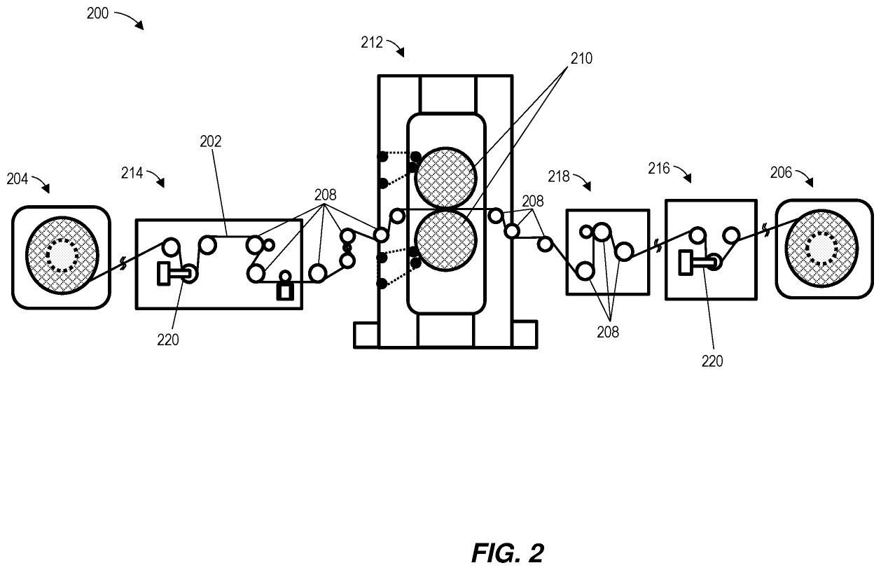

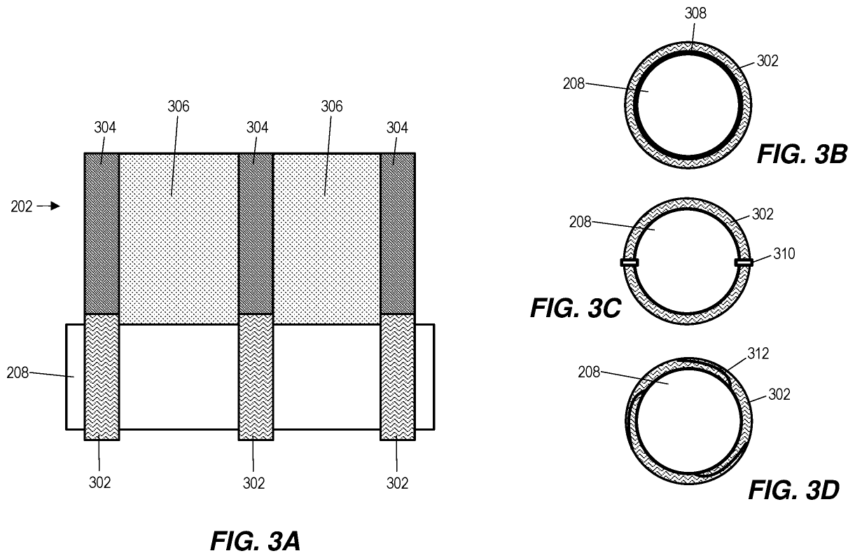

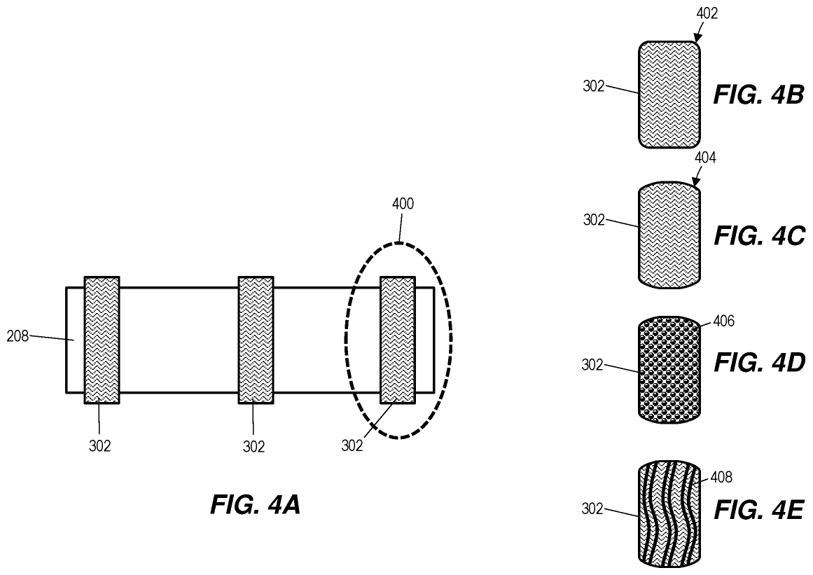

As will be detailed herein, the battery pack 108 includes one or more cells having electrodes with enhanced edge quality (that is, even elongation and reduced or eliminated wrinkles). In some embodiments, an electrode calendering system is modified via the incorporation of tensioning sleeves on the idle (or pull) roller(s) before or after the calendering rollers, or by tensioning the electrodes by controlling the dancer roller(s) and line speed, or by a combination of both (refer to FIG. 2). The tensioning sleeves can be incorporated using a number of mounting techniques (refer to FIGS. 3A, 3B, 3C, and 3D). The design of the shape and profile of the tensioning sleeves can themselves be customized for further optimizations (refer to FIGS. 4A, 4B, 4C, 4D, and 4E).

FIG. 2 illustrates an example configuration of an electrode calendering system 200 in accordance with one or more embodiments. As shown in FIG. 2, the electrode calendering system 200 can include a coated current collector 202 (itself made of a current collector foil and an electrode coating, not separately indicated) which is passed from an un-winder module 204 to a collector module 206 via a number of idle rollers 208 (also referred to as a pull roller or positioning rollers). The number and position of the idle rollers 208 is illustrative only and is not meant to be particularly limited.

The idle rollers 208 direct the coated current collector 202 between a pair of calendering rollers 210 (also referred to as a top roll press and a bottom roll press) of a calendering module 212 (also referred to as a roll press system) for calendering. In some embodiments, the electrode calendering system 200 includes an infeed module 214 positioned between the un-winder module 204 and the calendering module 212. In some embodiments, the electrode calendering system 200 includes an outfeed module 216 positioned between the calendering module 212 and the collector module 206. In some embodiments, the electrode calendering system 200 can include a gage thickness module 218 positioned before or after (as shown) the calendering module 212.

In some embodiments, the infeed module 214 and/or the outfeed module 216 include one or more dancer rollers 220. The dancer rollers 220 can be vertically and/or horizontally displaced (e.g., actuated via springs, levers, cams, and/or pneumatics) to change a travel length of the coated current collector 202, thereby changing an amount of tension applied to the coated current collector 202. It should be understood that the electrode calendering system 200 has been simplified for clarity and simplicity. The electrode calendering system 200 can include any number of additional rollers (e.g., guide rollers, positioning rollers, dancer rollers, etc.) and other roll-to-roll equipment (e.g., monitoring equipment such as high-speed cameras, foil guidance and tracking systems, support structures such as a steel frame, etc.) and all such configurations are within the contemplate scope of this disclosure.

In some embodiments, the coated current collector 202 includes a current collector coated with an active electrode material (refer to FIG. 3A). While not meant to be particularly limited, the active electrode material can include, for example, various cathode or anode materials (depending on the requirements of a specific application), such as, for example, activated carbon powder, nickel manganese cobalt oxide (NMC), lithium iron phosphate (LFP), nickel cobalt aluminum oxide (NCA), nickel cobalt manganese aluminum oxide (NCMA), lithium manganese iron phosphate (LMFP), lithium manganese rich (LMR), lithium manganese oxide (LMO), graphite, silicon, silicon-graphite composites, tin, tin oxide (SnO₂), lithium titanate (Li₄Ti₅O₁₂, LTO), sulfur and lithium-sulfur (Li—S) composites, lithium metal (Li), and/or lithium alloys such as lithium-antimony (Li—Sb), lithium-aluminum (Li—Al), and lithium-germanium (Li—Ge), and the like.

Similarly, the current collector (also referred to as the web or bare foil) is not meant to be particularly limited, but can include, for example, a sheet of conductive metal such as aluminum foil, stainless steel, and titanium foil. Other materials are possible, such as, for example, semimetals (e.g., tin, graphite), alloys of the metals and/or semimetals, conductive 2-dimensional wire mesh, conductive 3-dimensional wire mesh, conductive foam, and the like.

In some embodiments, the calendering rollers 210 are positioned to apply pressure onto the coated current collector 202. This process, known as calendering, is designed to improve the density, uniformity, and overall performance of the resulting pressed electrode (not separately indicated) by compressing and compacting an electrode material onto a portion of a current collector. The calendering rollers 210 can be made of a durable material, such as steel, and can be manufactured with precision surfaces (e.g., sub 10 micron tolerances) to ensure uniform pressure distribution. In some embodiments, a gap between the calendering rollers 210 can be adjusted by moving (e.g., hydraulically) one or both of the calendering rollers 210 to control the amount of pressure applied.

In some embodiments, the electrode calendering system 200 includes several control parameters, such as, for example, a roll temperature (top and/or bottom), a calendering pressure, a gap distance, and a line speed. In some embodiments, the roll temperature is up to 150 degrees Celsius, the pressure is up to 10 Mpa, and the line speed is 110 meters per minute, although other calendering configurations are within the contemplated scope of this disclosure. In some embodiments, the gap between the calendering rollers 210 can be adjusted (hydraulically or otherwise) to the desired thickness of the pressed electrode.

In some embodiments, a line speed and/or a pulling force of the electrode calendering system 200 is adjusted to target a predetermined over-tensioning of the coated current collector 202. In some embodiments, the predetermined over-tensioning is an amount of over-tensioning empirically known (via, e.g., prior runs of the roll-to-roll process) or simulationally predicted (via, e.g., Finite Element Analysis (FEA)) to achieve a wrinkle free pressed electrode post calendering. Observe that the line speed and/or pulling force required to achieve a wrinkle free pressed electrode (that is, post calendaring) will vary based on the loading (e.g., milligrams per centimeter squared) and density of the electrode material, the material selected for the current collector, and the target thickness of the pressed electrode. The line speed and/or pulling force can also vary based on additional factors including, but not limited to, electrode formulation, surface roughness, tensile properties, and the like.

The pulling force of the electrode calendering system 200 can be adjusted by vertically and/or horizontally displacing one or more of the dancer rollers 220 as discussed herein. For example, in some embodiments, the line speed of the electrode calendering system 200 is 10 m/s and the pulling force of the electrode calendering system 200 is 22 kg, although the pulling force and line speed can vary depending on the needs of the current configuration (e.g., electrode thickness, composition, etc.). All such configurations are within the contemplated scope of this disclosure. In some embodiments, the degree of deformation (pre-tensioning) can be observed (that is, can be empirically checked) for a number of pulling force and line speed combinations for a known electrode configuration.

FIG. 3A illustrates an example configuration of an idle roller 208 of the electrode calendering system 200 of FIG. 2 in accordance with one or more embodiments. As shown in FIG. 3A, the idle roller 208 (which itself can represent any one or more of the idle rollers 208 in FIG. 2) can include one or more tensioning sleeves 302. In some embodiments, the additional thickness of the tensioning sleeves 302 on the idle roller 208 serves to over-tension underlying portions of the coated current collector 202.

In some embodiments, the coated current collector 202 includes one or more bare foil portions 304 and one or more coated portions 306, and the tensioning sleeves 302 are positioned to align to the bare foil portions 304. In this manner, the tensioning sleeves 302 can be leveraged to over-tension the bare foil portions 304 of the coated current collector 202. Advantageously, this over-tensioning of the bare foil portions 304 of the coated current collector 202 is wholly or partially recovered during the calendering process (refer to FIG. 2), as calendaring naturally applies asymmetric stresses to the bare foil portions 304 and coated portions 306 of the coated current collector 202.

The number of tensioning sleeves 302 can be adjusted depending on the number of bare foil portions 304 of the coated current collector 202. For example, for single or double-sided coating applications, a pair of tensioning sleeves 302 can be positioned to cover the two exposed edges of the coated current collector 202. In lane coating applications (as shown), any number of tensioning sleeves 302 can be positioned to accommodate any number of coating lanes (as shown, three lanes, although 4, 5, 10 lanes, etc. are possible). In some embodiments, the number of tensioning sleeves 302 can be greater than the number of bare foil portions 304 of the coated current collector 202. In particular, one or more additional tensioning sleeves 302 can be positioned, for example, to aid in preventing warping of the electrode web (the coated current collector 202). In some embodiments, three tensioning sleeves 302 can be positioned such that a middle tensioning sleeve is placed over coated portions 306 of the coated current collector 202. In this scenario, a diameter of the middle tensioning sleeves (and any other sleeves of the tensioning sleeves 302) can be a few microns (e.g., 1 to 4 microns) larger than the pull roller (e.g., idle rollers 208), thereby allowing the middle tensioning sleeves to apply additional traction to the respective region of the coated current collector 202. In this manner overall warping of the electrode web can be reduced.

FIGS. 3B, 3C, and 3D illustrate example mounting configurations of the tensioning sleeves 302 of the idle roller 208 of FIG. 3A in accordance with one or more embodiments. FIG. 3B illustrates a press fitting and/or adhesive mounting scheme. FIG. 3C illustrates a set screw(s) mounting scheme. FIG. 3D illustrates a leaf spring(s) mounting scheme. Regardless of the configuration, in some embodiments, the tensioning sleeves 302 can be dynamically adjusted. Adjustments can be made, for example, using smart materials, adjustable elliptical springs, sleeve expansion by heating or cooling the sleeves, etc.

As shown in FIG. 3B, the tensioning sleeves 302 can be fixed to the idle roller 208 using a press fitting and/or adhesive 308. The press fitting and/or adhesive 308 is not meant to be particularly limited, but can be selected, for example, depending on the material, thickness, and/or other characteristic(s) of the tensioning sleeves 302 and/or the idle roller 208. For example, the press fitting and/or adhesive 308 can include a polyurethane blend for metal-to-polymer applications.

As shown in FIG. 3C, the tensioning sleeves 302 can be fixed to the idle roller 208 using one or more set screws 310. The number and type of set screws 310 is not meant to be particularly limited, and all such configurations are within the contemplated scope of this disclosure.

As shown in FIG. 3D, the tensioning sleeves 302 can be fixed to the idle roller 208 using one or more leaf springs 312. The number and type of leaf springs 312 is not meant to be particularly limited, and all such configurations are within the contemplated scope of this disclosure. Advantageously, the tensioning sleeves 302 can be dynamically adjusted in this configuration by adjusting the tension in the leaf springs 312.

FIG. 4A illustrates an example configuration of an idle roller 208 of the electrode calendering system 200 of FIG. 2 in accordance with one or more embodiments. FIGS. 4B, 4C, 4D, and 4E illustrate example profile configurations for the tensioning sleeve 302 in the detailed view 400 of FIG. 4A in accordance with one or more embodiments.

FIG. 4B illustrates a relatively rapid tapering 402 of the tensioning sleeve 302. As used herein, a relatively rapid tapering means a tapering which completes within less than 20 percent, or 10 percent, of the width of the tensioning sleeve 302. In this manner, the tensioning sleeve 302 offers a flat profile suitable for applications having consistent electrode coating thicknesses.

FIG. 4C illustrates a relatively slow tapering 404 of the tensioning sleeve 302. As used herein, a relatively slow tapering means a tapering which occurs over at least 50 percent, 60 percent, 75 percent, 90 percent, or 100 percent (as shown) of the width of the tensioning sleeve 302. In this manner, the tensioning sleeve 302 offers a concave (or alternatively, convex) profile suitable for applications where the electrode coating thicknesses increases (or decreases) along the width of the coated current collector 202.

FIG. 4D illustrates a tensioning sleeve 302 having a patterned texture 406 rather than a smooth texture as shown in FIGS. 4B and 4C. The patterned texture 406 can include any number of protrusions and/or divots arranged in any desirable configuration and all such configurations are within the contemplated scope of this disclosure. In some embodiments, the patterned texture 406 is uniform (within tooling limits) across the tensioning sleeve 302. In some embodiments, the patterned texture 406 is asymmetric across the tensioning sleeve 302. For example, the number, size, position, pitch, and/or orientation of the protrusions and/or divots of the patterned texture 406 can vary across the tensioning sleeve 302 to target any desired over-tensioning geometry and all such configurations are within the contemplated scope of this disclosure.

FIG. 4E illustrates a tensioning sleeve 302 having a number of grooves 408 arranged over the tensioning sleeve 302. The number, size, position, pitch, and/or orientation of the grooves 408 can vary as desired to target any desired over-tensioning geometry and all such configurations are within the contemplated scope of this disclosure.

While the example configurations of the tensioning sleeves 302 shown in FIGS. 4B, 4C, 4D, and 4E are depicted as having substantially the same width, this is for convenience only. It is not necessary for the tensioning sleeves 302 of the idle rollers 208 to have the same width. Similarly, it is not necessary for the tensioning sleeves 302 to have the same thickness and/or taper and all such configurations are within the contemplated scope of this disclosure. Moreover, any tapering, if present, can be symmetric or restricted to a single side (e.g., outside edge, inside edge) of the tensioning sleeves 302.

In some embodiments, a thickness of the tensioning sleeves 302 for a given application is selected to target a predetermined over-tensioning of the coated current collector 202. In some embodiments, the predetermined over-tensioning is an amount of over-tensioning empirically known (via, e.g., prior runs of the roll-to-roll process) or simulationally predicted (via, e.g., Finite Element Analysis (FEA)) to achieve a wrinkle free pressed electrode post calendering. Observe that the thickness required to achieve a wrinkle free pressed electrode (that is, post calendaring) will vary based on the loading (e.g., milligrams per centimeter squared) and density of the electrode material, the material selected for the current collector, and the target thickness of the pressed electrode. Moreover, band thickness can be selected based on any of a number of design and/or target parameters, such as flexural strength, strain, elongation, thickness of the electrode, and/or yield strength. The band thickness can also vary based on additional factors including, but not limited to, electrode formulation, surface roughness, tensile properties, and the like. In some embodiments, for example, the tensioning sleeves 302 can be formed to a thickness of 50 to 100 microns, for example, 70 microns, although other thicknesses are within the contemplated scope of this disclosure. In some embodiments, the tensioning sleeves 302 can be placed over the idle rollers 208 by wrapping material over the idle rollers 208. In some embodiments, the tensioning sleeves 302 are wrapped over the idle rollers 208 at a greater than 90 degrees wrap angle.

The tensioning sleeves 302 can be made of a material having a known elasticity selected depending on the design calendering pressures. For example, while not meant to be particularly limited, the tensioning sleeves 302 can be made of metals such as aluminum, stainless steel, steel alloy, etc., or of polymers and/or elastomers such as silicon mixed with a polymer such as polypropene, thermoplastic polymers such as polyethylene terephthalate (PET) and polyvinylidene fluoride (PVDF), polyethylene (PE), including low-density polyethylene (LDPE) and high-density polyethylene (HDPE), polytetrafluoroethylene (PTFE), polyamides such as nylon, synthetic rubbers such as neoprene, hybrid materials with glass fibers, silicon oxide, etc., polymers and metal laminates with rubber, and the like.

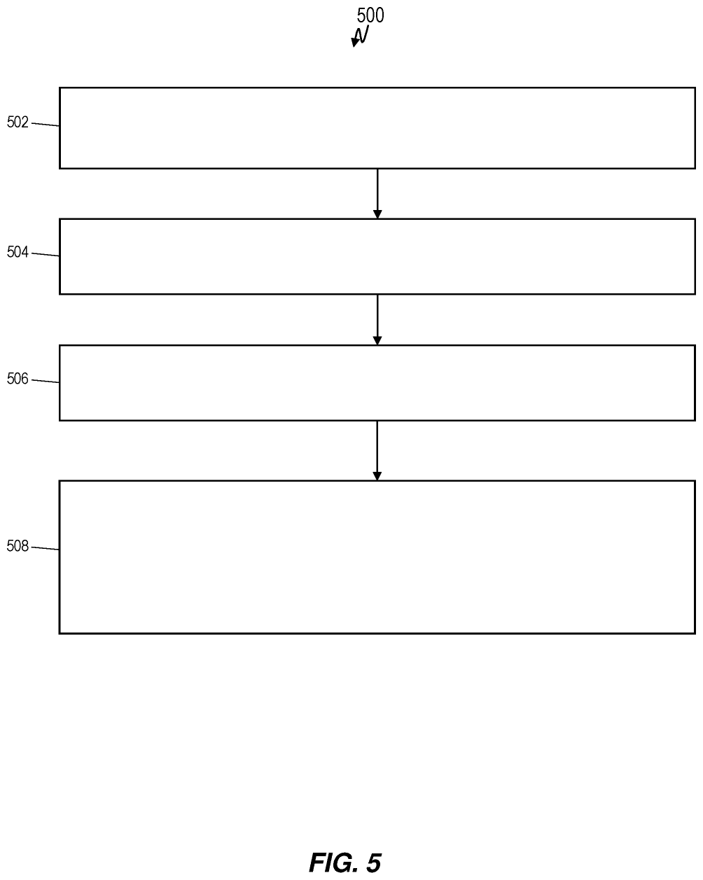

Referring now to FIG. 5, a flowchart 500 for manufacturing electrodes using an electrode calendering system that leverages electrode foil edge tensioning to reduce calendering wrinkling is generally shown according to an embodiment. The flowchart 500 is described in reference to FIGS. 1-4E and may include additional steps not depicted in FIG. 5. Although depicted in a particular order, the blocks depicted in FIG. 5 can be rearranged, subdivided, and/or combined.

At block 502, the method includes providing a calendering module having a pair of calendering rollers separated by a gap. The gap includes a distance selected to accommodate a current collector. The current collector includes a bare portion and a coated portion having thereon an active electrode material of a first thickness.

At block 504, the method includes providing an un-winder module upstream of the calendering module. At block 506, the method includes providing a collector module downstream of the calendering module.

At block 508, the method includes providing one or more idle rollers positioned between the un-winder module and the collector module. In some embodiments, an idle roller of the one or more idle rollers includes a tensioning sleeve having a second thickness. In some embodiments, the second thickness is selected, based on the first thickness, to over-tension underlying portions of the current collector. In some embodiments, the tensioning sleeve is aligned to the bare portion of the current collector (that is, it is the bare portions which are over-tensioned).

In some embodiments, calendering pressures incurred during the calendering module serve to correct the over-tensioning applied to the bare portion of the current collector, thereby reducing foil wrinkles post-calendering.

In some embodiments, the tensioning sleeve is fixed to the respective idle roller of the one or more idle rollers using at least one of a press fitting and an adhesive. In some embodiments, the tensioning sleeve is fixed to the respective idle roller of the one or more idle rollers using one or more set screws. In some embodiments, the tensioning sleeve is fixed to the respective idle roller of the one or more idle rollers using one or more leaf springs.

In some embodiments, the tensioning sleeve is tapered.

In some embodiments, the tensioning sleeve includes at least one of a patterned texture having one or more protrusions (refer to FIG. 4D), one or more divots (refer to FIG. 4D), or one or more grooves (refer to FIG. 4E).

In some embodiments, at least one of a line speed and a pulling force of the current collector is adjusted to tune the over-tensioning applied to the bare portion of the current collector.

In some embodiments, the method includes providing one or more dancer rollers positioned between the un-winder module and the collector module. In some embodiments, the pulling force of the current collector is adjusted by displacing a position of at least one of the one or more dancer rollers.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A roll-to-roll system for manufacturing electrodes, the system comprising:
a calendering module comprising a pair of calendering rollers separated by a gap, the gap comprising a distance selected to accommodate a current collector, the current collector comprising a bare portion and a coated portion having thereon an active electrode material of a first thickness;
an un-winder module upstream of the calendering module;
a collector module downstream of the calendering module; and
one or more idle rollers positioned between the un-winder module and the collector module;
wherein an idle roller of the one or more idle rollers comprises a tensioning sleeve comprising a second thickness selected, based on the first thickness, to over-tension underlying portions of the current collector, the tensioning sleeve aligned to the bare portion of the current collector.

2. The roll-to-roll system of claim 1, wherein calendering pressures incurred during the calendering module serve to correct the over-tensioning applied to the bare portion of the current collector, thereby reducing foil wrinkles post-calendering.

3. The roll-to-roll system of claim 1, wherein the tensioning sleeve is fixed to a respective idle roller of the one or more idle rollers using at least one of a press fitting and an adhesive.

4. The roll-to-roll system of claim 1, wherein the tensioning sleeve is fixed to a respective idle roller of the one or more idle rollers using one or more set screws.

5. The roll-to-roll system of claim 1, wherein the tensioning sleeve is fixed to a respective idle roller of the one or more idle rollers using one or more leaf springs.

6. The roll-to-roll system of claim 1, wherein the tensioning sleeve is tapered.

7. The roll-to-roll system of claim 1, wherein the tensioning sleeve comprises at least one of a patterned texture comprising one or more protrusions, one or more divots, or one or more grooves.

8. The roll-to-roll system of claim 1, wherein at least one of a line speed and a pulling force of the current collector is adjusted to tune the over-tensioning applied to the bare portion of the current collector.

9. The roll-to-roll system of claim 8, further comprising one or more dancer rollers positioned between the un-winder module and the collector module.

10. The roll-to-roll system of claim 9, wherein the pulling force of the current collector is adjusted by displacing a position of at least one of the one or more dancer rollers.

11. A method comprising:
providing a calendering module comprising a pair of calendering rollers separated by a gap, the gap comprising a distance selected to accommodate a current collector, the current collector comprising a bare portion and a coated portion having thereon an active electrode material of a first thickness;
providing an un-winder module upstream of the calendering module;
providing a collector module downstream of the calendering module; and
providing one or more idle rollers positioned between the un-winder module and the collector module;
wherein an idle roller of the one or more idle rollers comprises a tensioning sleeve comprising a second thickness selected, based on the first thickness, to over-tension underlying portions of the current collector, the tensioning sleeve aligned to the bare portion of the current collector.

12. The method of claim 11, wherein calendering pressures incurred during the calendering module serve to correct the over-tensioning applied to the bare portion of the current collector, thereby reducing foil wrinkles post-calendering.

13. The method of claim 11, wherein the tensioning sleeve is fixed to a respective idle roller of the one or more idle rollers using at least one of a press fitting and an adhesive.

14. The method of claim 11, wherein the tensioning sleeve is fixed to a respective idle roller of the one or more idle rollers using one or more set screws.

15. The method of claim 11, wherein the tensioning sleeve is fixed to a respective idle roller of the one or more idle rollers using one or more leaf springs.

16. The method of claim 11, wherein an additional idle roller of the one or more idle rollers is positioned over the coated portion of the current collector, the additional idle roller comprising an additional tensioning sleeve having a diameter that is 1 to 4 microns larger than a diameter of the additional idle roller.

17. The method of claim 11, wherein the tensioning sleeve comprises at least one of a patterned texture comprising one or more protrusions, one or more divots, or one or more grooves.

18. The method of claim 11, wherein at least one of a line speed and a pulling force of the current collector is adjusted to tune the over-tensioning applied to the bare portion of the current collector.

19. The method of claim 18, further comprising one or more dancer rollers positioned between the un-winder module and the collector module.

20. The method of claim 19, wherein the pulling force of the current collector is adjusted by displacing a position of at least one of the one or more dancer rollers.
